(19) United States
(12) Patent Application Publication
(10) Pub. No.: US 2006/0088146 A1
(43) Pub. Date: Apr. 27, 2006

(54) Telephone device with integral apparatus for simulating telephone "in use" signals in a line in a telephone ring system

(76) Inventor: Anthony G. D'Egidio, Boca Raton, FL (US)

Correspondence Address: BENASUTTI, P.A., 17294 BERMUDA VILLAGE DRIVE, BOCA RATON, FL, 33487, US

(21) Appl. No.: 11/240,165

(22) Filed: Sep. 29, 2005

Related U.S. Application Data
(63) Continuation-in-part of application No. 11/152,441, filed on Jun. 14, 2005.
(60) Provisional application No. 60/621,907, filed on Oct. 25, 2004.

(51) Int. Cl. H04M 11/00

(52) U.S. Cl. 379/100.01; 379/350

(57) ABSTRACT

A system, apparatuses and a method is disclosed for use in a facsimile machine, a telephone and a VoIP system, for simulating an “in use” condition in a telephone line in those devices, so that incoming calls will get a busy signal and, therefore, will not ring all telephones on that line.

### CROSS REFERENCE TO RELATED APPLICATIONS

This application is a continuation-in-part of my prior co-pending application Ser. No. 11/152,441 filed Jun. 14, 2005 entitled “Apparatus and method of simulating telephone “in use” signals in a line in a telephone ring system”, which incorporated by reference my prior co-pending provisional patent application No. 60/621,907 filed Oct. 25, 2004 entitled “Digital controller for telephone lines”, both of which are incorporated herein by reference as if fully set forth.

### BACKGROUND OF THE INVENTION

1. Technical Field

The present invention relates to control of incoming telephone calls, and more particularly, to simulating “in use” signals to prevent incoming calls from ringing telephone devices connected to the same line.

2. Background

It may be desirable to prevent incoming telephone calls, from time to time, from ringing the telephone. Simply disconnecting the telephone does not provide an adequate solution for this purpose.

The prior art provides a variety of mechanical solutions as well as complex electrical systems. See for example, U.S. Pat. No. 3,867,584 which discloses a do-not-disturb adapter (including a rotating cam) for telephone receivers. Pending U.S. patent application Ser. No. 10/379,301, Publication number US 2004/0174970 A1 discloses another mechanical telephone line isolation device. U.S. Pat. No. 4,405,839 discloses a timed telephone ring silencer device.

I have invented an inexpensive electrical apparatus and method for simulating an “in use” signal to prevent incoming calls from ringing telephones connected to the same line. I provide a timing controller means for setting and resetting time intervals; which is repeatable, which provides for “do-not-disturb” and which can be easily switched on and off. I have incorporated this invention into a telephone device, such as a telephone receiver or facsimile machine.

### SUMMARY OF INVENTION

In a telephone system having a circuit which provides a busy signal in a telephone line when the telephone is in an “in use” mode, I have invented a simulation means to simulate an “in use” mode, comprising:
a. switch means switchable between an open circuit position and a closed circuit position;
b. relay means connected to said switch means to switch said switch means between said positions;
c. controller means connected to said relay means to cause said relay means to switch said switch means as aforesaid; and
d. time set means connected to said controller means to set time intervals that the controller means causes the relay means to switch said switch means as aforesaid.

I also invented a method of simulating an “in use” mode in a telephone system having a circuit which provides a busy signal in a telephone line when the telephone is in an “in use” mode, comprising providing a switch means in said circuit, switchable between an open circuit position and a closed circuit position; providing a relay means connected to said switch means to switch said switch means between said positions; providing a controller means connected to said relay means to cause said relay means to switch said switch means as aforesaid; and providing time set means connected to said controller means to set time intervals that the controller means causes the relay means to switch said switch means as aforesaid.

### BRIEF DESCRIPTION OF THE DRAWINGS

FIG. 1 is a block diagram of a telephone apparatus in accordance with my invention;

FIG. 2 is a top, front perspective view of a stand alone console which is a part of the apparatus in accordance with my invention;

FIG. 3 is a top, rear perspective view of the stand alone console which is shown in FIG. 2, showing additional parts;

FIGS. 4a and 4b are schematic diagrams of a portion of my apparatus;

FIG. 5 is a schematic diagram of another portion of my apparatus;

FIG. 6 is a schematic diagram of another portion of my apparatus;

FIG. 7 is a schematic diagram of another portion of my apparatus;

FIG. 8 is a block diagram of a facsimile machine having an integral apparatus for simulating telephone “in use” signals in a line in a telephone ring system therein, in accordance with my invention;

FIG. 9 is a top, front perspective view of a facsimile machine having an integral apparatus for simulating telephone “in use” signals in a line in a telephone ring system therein, in accordance with my invention;

FIG. 10 is a side view of a facsimile machine similar to that shown in FIG. 9;

FIG. 11 is a block diagram of a telephone base station and having an integral apparatus for simulating telephone “in use” signals in a line in a telephone ring system therein, in accordance with my invention;

FIG. 12 is a top, front perspective view of a telephone having an integral apparatus for simulating telephone “in use” signals in a line in a telephone ring system therein, in accordance with my invention;

FIG. 13 is a rear view of a telephone similar to that shown in FIG. 12;

FIG. 14 is a diagram showing a computer voice over internet protocol apparatus;

FIG. 15 is a block diagram showing a computer voice over internet protocol apparatus;

FIG. 16 is a top, front perspective view of an internet protocol telephone adapter having an integral apparatus for simulating telephone “in use” signals in a line in a telephone ring system therein, in accordance with my invention; and

FIG. 17 is a rear view of a telephone adapter similar to that shown in FIG. 16.

### DETAILED DESCRIPTION OF THE PREFERRED EMBODIMENT OF THE INVENTION

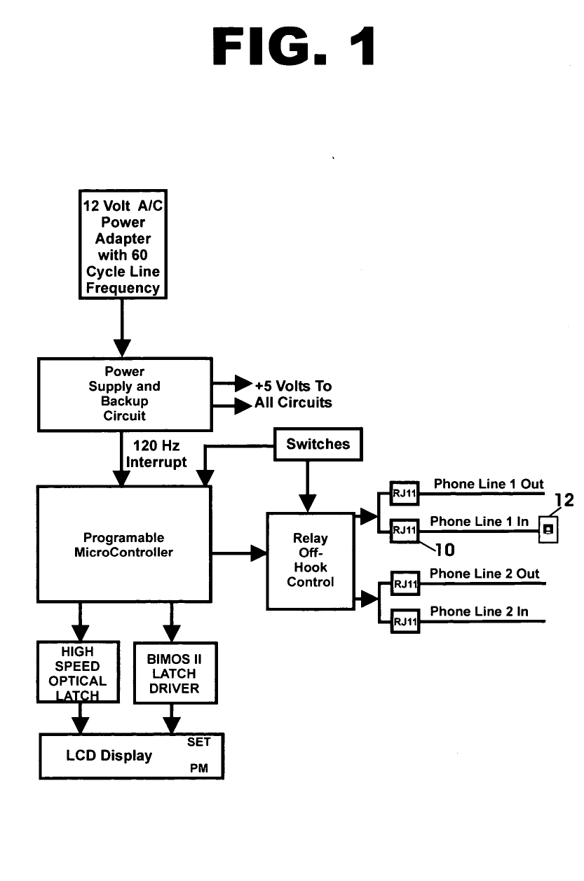

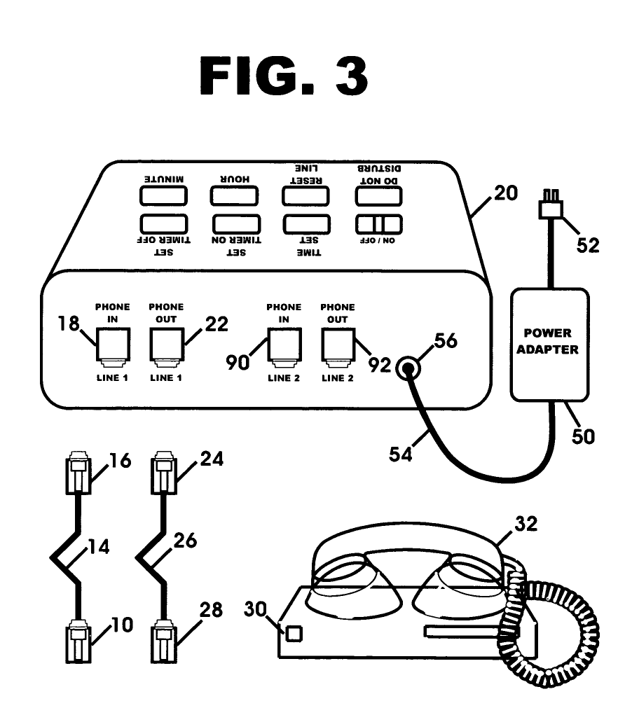

Referring to the Figures, FIG. 1 shows at 10 a known RJ111 telephone plug for use in connecting a telephone line 14 (FIG. 3) of the type commonly used in a telephone handset, to the telephone jack 12 provided by a telephone signal provider. The other end of the line 14 also has an RJ11 plug 16 for connection with a jack 18 of the same type as jack 12. Jack 18 is mounted in a console 20 (FIG. 3). Also mounted in the console 20 is jack 22. Telephone line 26 has plugs 24, 28 at each end to connect the console to the telephone receiver 32 (as at jack 30). Calls can be received and placed through the telephone in the usual fashion.

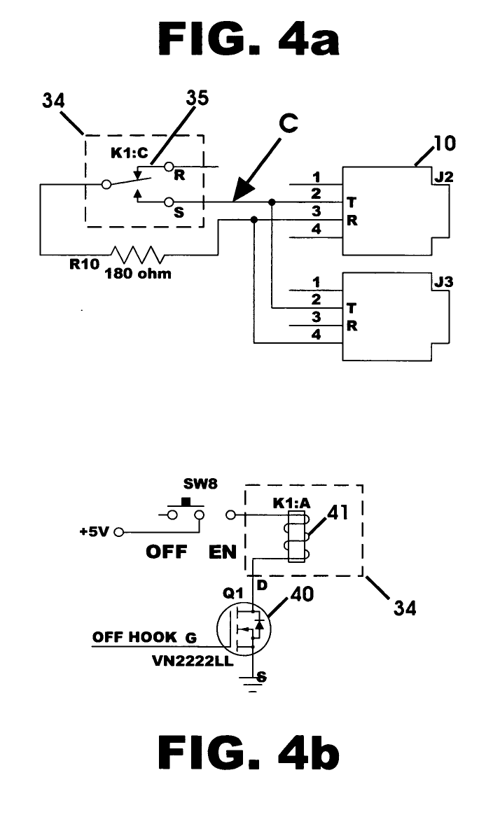

Normally an incoming call will cause the telephone to ring. Lines T and R, of plug 10 FIG. 4a provide a part of a circuit designated generally “C” into my apparatus. If these lines are connected (as, for example, when the telephone is “in use”), an incoming call will be met by a busy signal; and the telephone will not ring. In accordance with my invention, I simulate the “in use” condition to, thus, prevent the ringing of the telephone. Furthermore, my device will prevent the ringing of all telephones on the same line; without the need to connect additional devices.

FIGS. 4a and 4b show a relay designated 34 in circuit “C”. In its normal condition, the relay switch 35, as shown, is “open”; allowing for normal telephone operation.

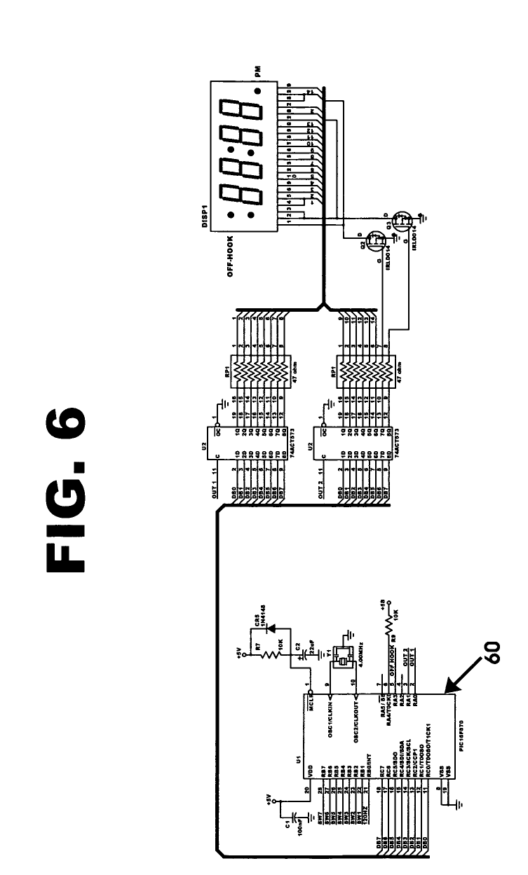

FIG. 4b shows a detail of the relay 34. To close the relay switch 35, I provide a controller means comprising a transistor means and a microcontroller means. An input signal is provided to a small signal mosfet transistor 40 (in the transistor means) from a microcontroller 60, FIG. 6 (in the controller means). The transistor 40 thereupon creates a circuit to allow the coil 41 in the relay to activate and, thereby, close the switch 35 to the plug 10. This closed circuit simulates a busy signal to incoming calls, because of the resistance provided by the 180 ohm resister. As a result, an “in use” mode is simulated in the line and all telephones on that line are prevented from ringing.

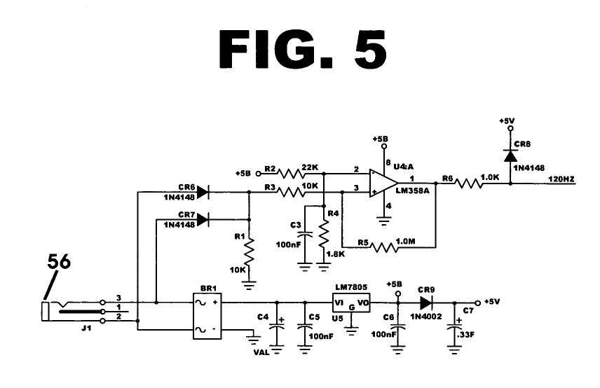

A power adapter/transformer 50, FIG. 3 is provided to be plugged into a standard 120 volt AC, 60 cycle source via plug 52. It provides 5 volt AC current via cord 54 to a power supply connector 56 in the console 20 (FIGS. 3 and 5). This is used to supply 5 volts AC all electrical components. The schematic for the power supply circuit is shown in FIG. 5.

When my timer in the console cuts off the signal to the transistor 40, it no longer functions to complete the circuit to the relay, and the relay returns to its normal condition. This opens the circuit and allows all telephones on the same line to return to their normal operating condition.

The console 20 contains a microcontroller (designated generally 60, FIG. 6) which is a flash Microcontroller, such as, part number PIC16F870 supplied by Microchip Technology, Inc, 2355 West Chandler Boulevard, Chandler, Ariz. 85224-6199. This functions through PORTC of the microchip interfacing with two 74ACT573 high speed octal latches that drive a 0.9 LED clock display allowing for the exhibiting of hours, minutes, PM and Set functions. All timing and control functions are achieved by the programming of the PIC16F870, on board Data EEPROM. However, other manufacturers' products may be used.

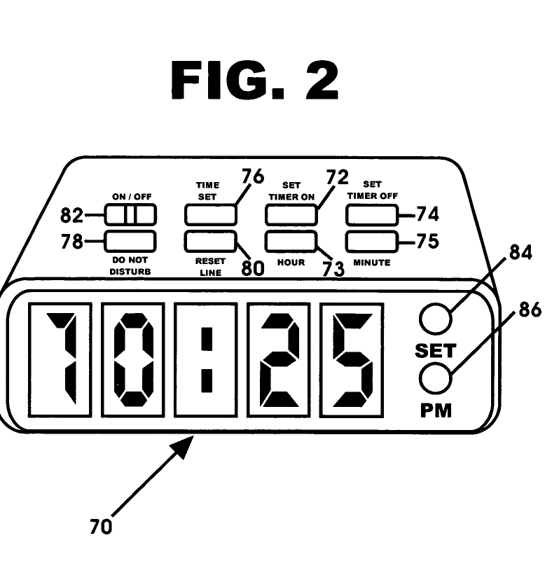

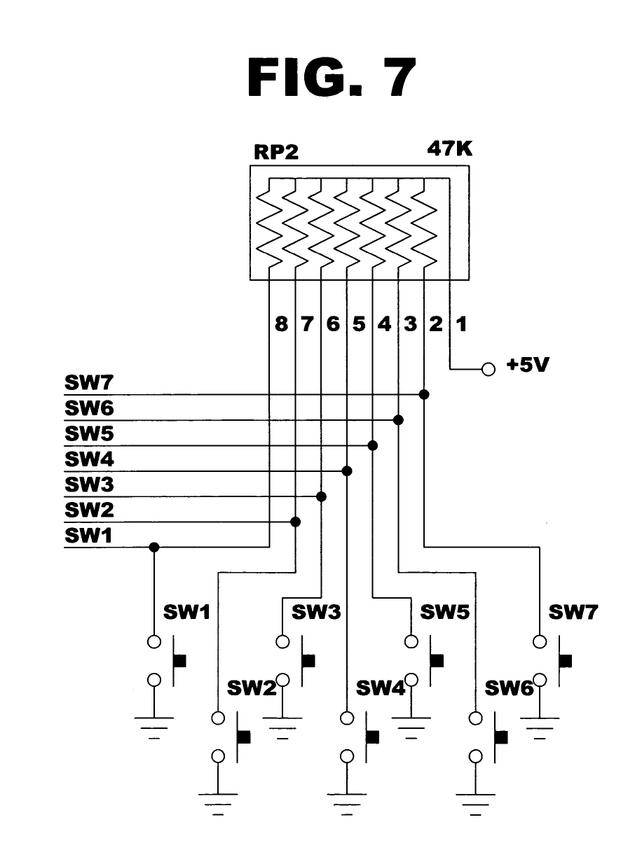

Eight activating switches (shown on top, FIG. 2) are provided to control all functions through PIC16F870 PORTB interface. The schematic for seven of these momentary contact switches is shown on FIG. 7. The eighth is shown on FIG. 4b. The clock timing apparatus (designated generally 70, FIG. 2), provides the following functions:

“Set Timer On” (button 72) to control the start of a simulated “in use” condition; in minutes (button 75) and hours (button 73).

“Set Timer Off”(button 74) to control the end of the simulated “in use” condition; in minutes (button 75) and hours (button 73).

Once set, these two times remain as set until they are changed. They are, thus, repeatable from day to day.

“Time Set” (button 76) to set the clock to the time of day in minutes (button 75) and hours (button 73).

“Do Not Disturb” (button 78) to provide a second type of “on” function for the simulated “in use” condition. This is pre-programed for a set interval of time, say, 15 minutes by pressing the “Do Not Disturb” button 78 and the minute button 75. Each time the button 78 and the minute button 75 are pressed, it adds 15 minutes more; for up to a maximum, such as, 60 minutes. This function can also be set for other time intervals, such as, by pressing the “Do Not Disturb” button 78 and the hour button 73. Each time the button 78 and the hour button 73 are pressed, it adds another hour more; for up to a maximum, such as, 6 hours. This is a non-repeatable function, that is, once it runs out it does not repeat the next day.

The “Do Not Disturb” function can also be aborted by pressing the “Reset Line” button 80. “Reset line” (button 80) to release the prior “set” times and brings the telephone back to its normal operating condition. However, the repeatable functions are still in place for the next day.

“On/Off” (switch 82) to control the operation of the relay 34 and prevent the apparatus from functioning to simulate the “in use” mode.

There is also a “Set” light 84 on the front of the consol to indicate when the device has been activated and a “PM” light 86 on the front of the console to indicate the time of day. The method of operation is as follows.

To set the clock's time of day, simultaneously push “Time Set” and “Hour” buttons to select the hour and release the buttons to “Set” the selected hour. Simultaneously push “Time Set” and “Minute” buttons to select the minute and release the buttons to “Set” the selected minute.

To set the repeatable start time to simulate telephone “in use”, simultaneously push “Set Timer On” and “Hour” buttons to select the hour and release the buttons to “Set” the selected hour. Simultaneously push “Set Timer On” and “Minute” buttons to select the minute and release the buttons to “Set” the selected minute.

To set the repeatable time to stop the simulated telephone “in use” function, simultaneously push “Set Timer Off” and “Hour” buttons to select the hour and release the buttons to “Set” the selected hour. Simultaneously push “Set Timer Off” and “Minute” buttons to select the minute and release the buttons to “Set” the selected minute. Once the timed cycle is completed, the telephone line is restored to its normal condition; until the next day. On the next day, the on/off cycle repeats.

The ON/OFF switch allows the user to disconnect and reconnect the device to control the operation of the telephone line. When disconnected by this switch, the telephone line operates as usual.

Multiple lines can be controlled at the same time, such as one additional line by using additional telephone jacks 90, 92, FIG. 3 and additional telephone lines (not shown).

The following figures illustrate my invention in digital telephone controller functions utilized in facsimile machines, telephones with or without answering machines and voice over internet protocol (VoIP) telephone adapters.

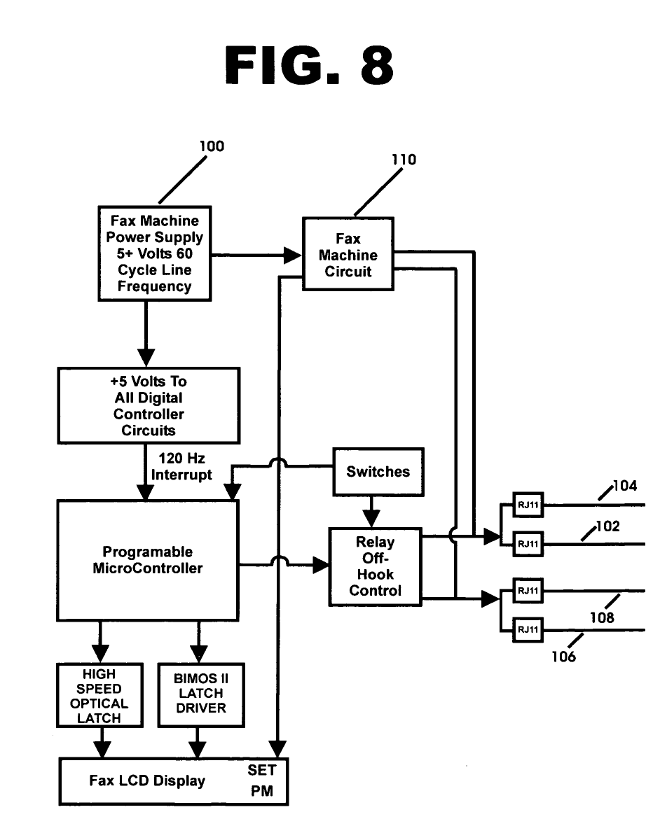

FIG. 8 is a block diagram of a facsimile machine having an integral apparatus for simulating telephone “in use” signals in a line in a telephone ring system therein, in accordance with my invention substantially as described hereinabove. In FIG. 8, however, since a facsimile machine 100 is being used, there is no need for a separate power supply or adapter. The facsimile machine circuit is shown at 110. There are two sets of telephone “in” “out” lines illustrated at 102 104 and 106 108 respectively. This arrangement functions identically to the system described hereinabove to interrupt the incoming call signal to the facsimile machine.

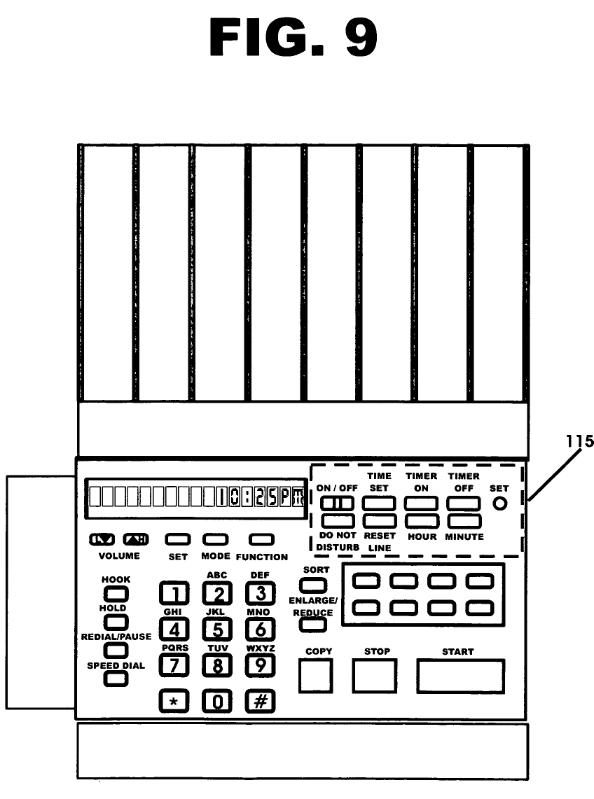

FIG. 9 is a top, front perspective view of a facsimile machine having the integral apparatus for simulating telephone “in use” signals in a line in a telephone ring system therein, in accordance with my invention. The panel functions of the facsimile machine 115 are the same as previously described in connection with FIG. 2.

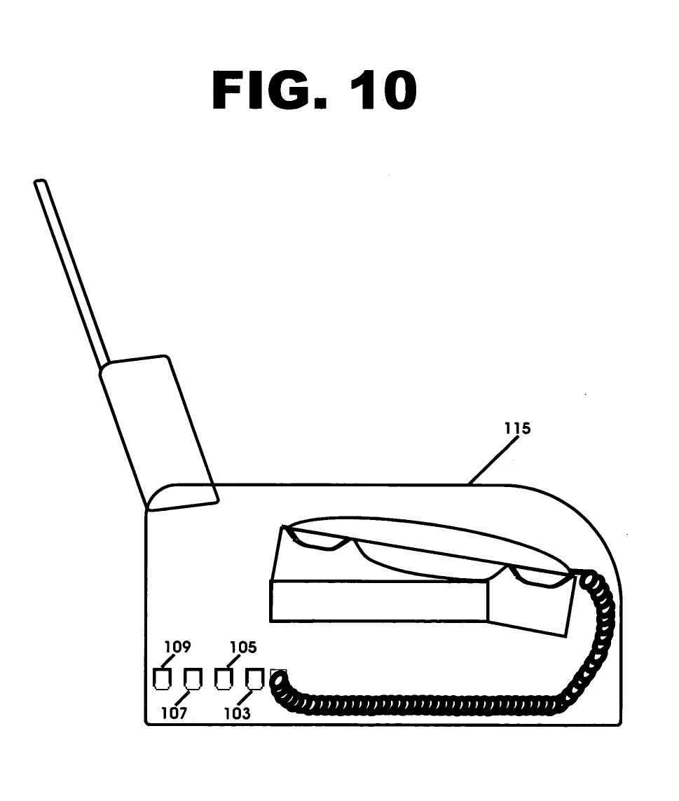

FIG. 10 is a side view of a facsimile machine similar to that shown in FIG. 9. Two pairs of telephone line “in” and line “out” jacks (103, 105, 107 and 109) are mounted in the housing of the facsimile machine 115.

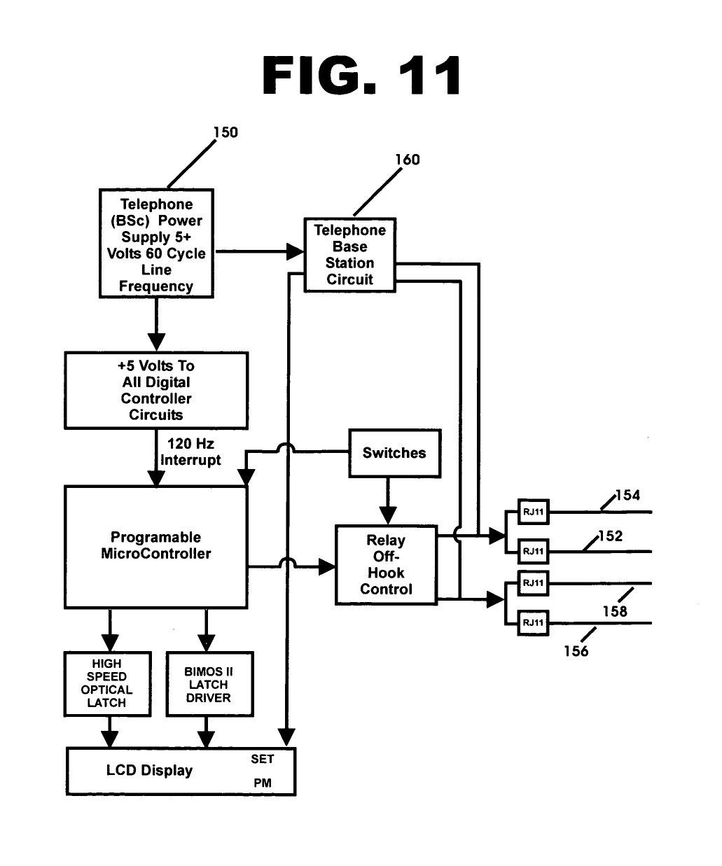

FIG. 11 is a block diagram of a telephone base station (which may have answering capability) having an integral apparatus for simulating telephone “in use” signals in a line in a telephone ring system therein, in accordance with my invention. In FIG. 11, however, since a telephone machine has is own power source 150, there is no need for a separate power supply or adapter. The telephone base station circuit is shown at 160. There are two sets of telephone “in” “out” lines illustrated at 152 154 and 156 158 respectively. This arrangement functions identically to the system described hereinabove to interrupt the incoming call signal to the telephone machine as has previously been described.

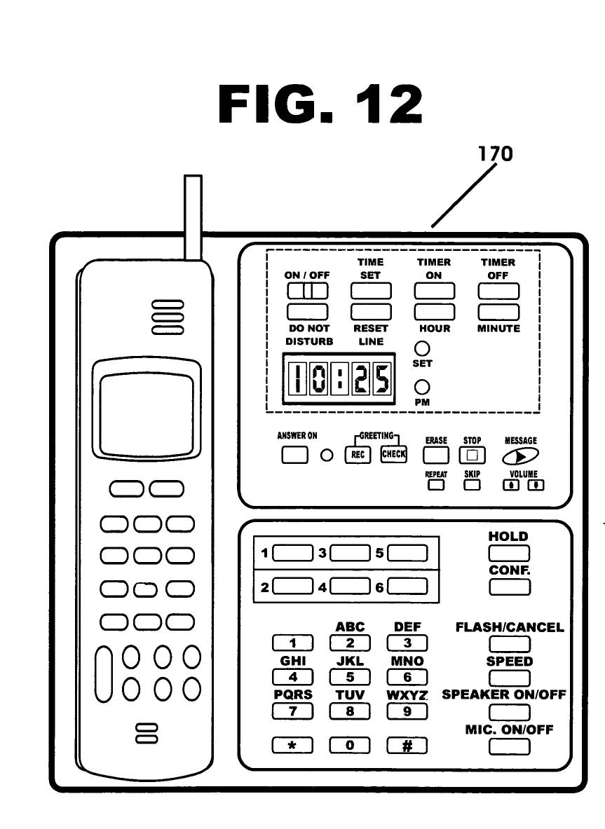

FIG. 12 is a top, front perspective view of a telephone 170 having an integral apparatus for simulating telephone “in use” signals in a line in a telephone ring system therein, in accordance with my invention. The panel functions of the telephone base station 170 are the same as previously described in connection with FIG. 2.

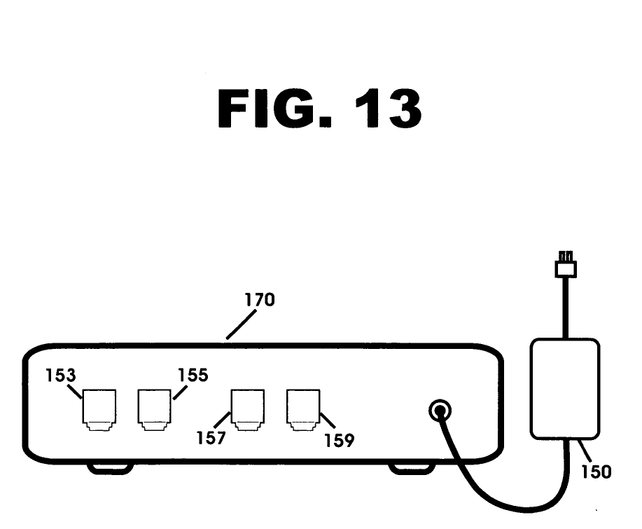

FIG. 13 is a rear view of a telephone base station similar to that shown in FIG. 12. Two pairs of telephone line “in” and line “out” jacks 153, 155, 157 and 159 for the lines are mounted in the housing of the telephone base station 170.

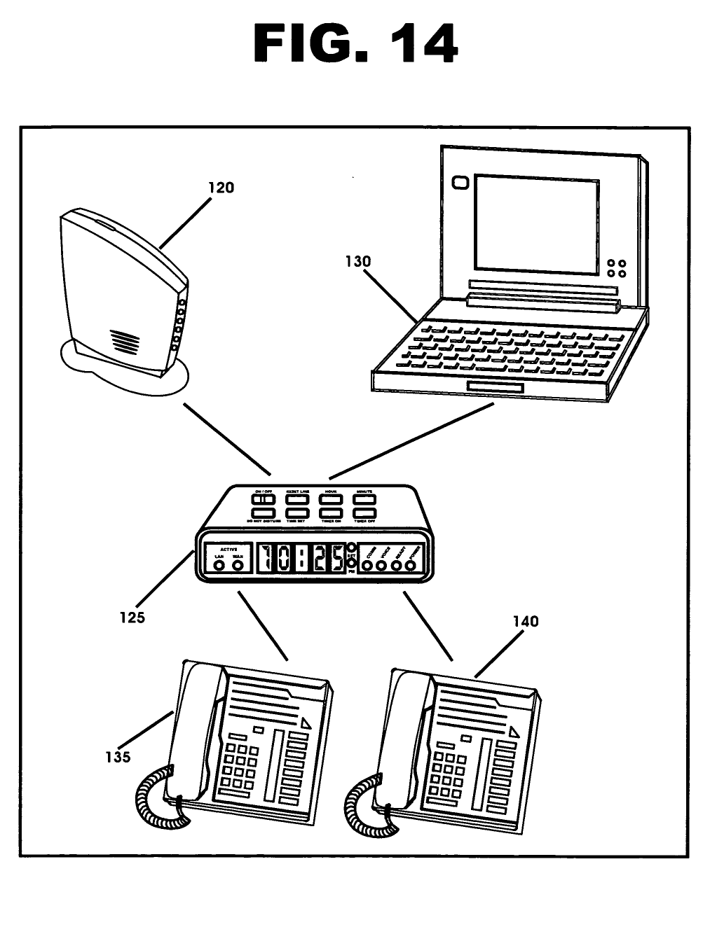

FIG. 14 is a diagram showing a computer voice over internet apparatus. 120 is a DSL/cable modem. 125 is a voice over internet (VoIP) protocol adapter. 130 is a computer connected via a LAN (local area network) port of the voice over internet (VoIP) protocol adapter 125 to the ethernet port of the computer. 135 and 140 are two telephones connected to the voice over internet (VoIP) protocol adapter 125.

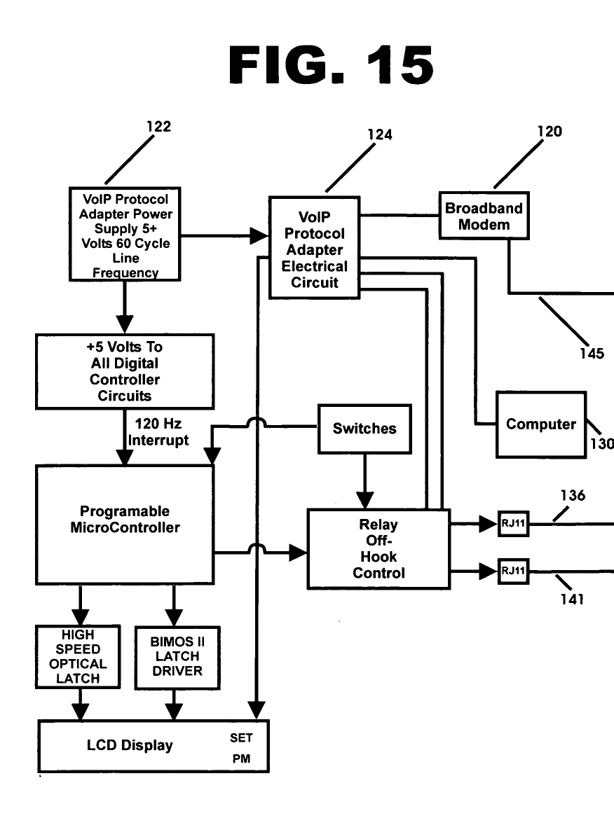

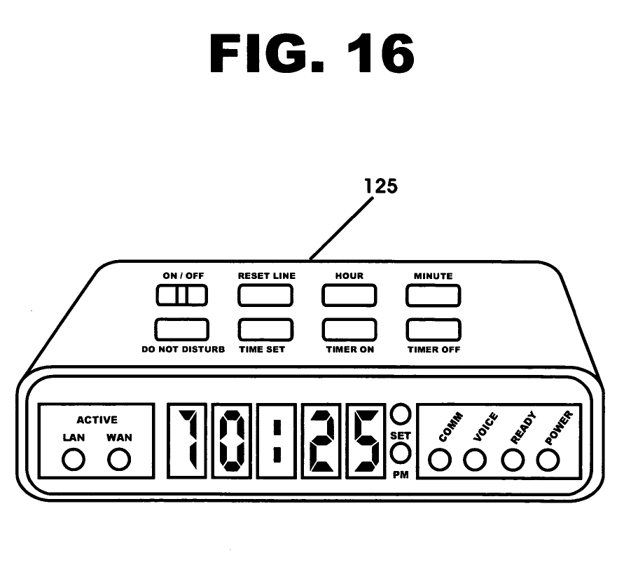

FIG. 15 is a block diagram showing the computer voice over internet (VoIP) protocol apparatus. Here again the system has its own power source 122. The electric circuit is shown at 124 and is connected to the modem 120. 145 is the connection to the internet. 136 and 141 are the telephone lines going out to the telephones 135 and 140. Note that there are no incoming telephone lines, because the VoIP provides the telephone link via the broadband modem. When my digital controller is activated, before the signal can go out to the telephone, the VoIP adaptor senses the “in use” condition (in accordance with my invention as described hereinabove) and presents a busy signal to the caller. FIG. 16 is a top, front perspective view of the internet protocol telephone adapter 125 having an integral apparatus for simulating telephone “in use” signals in a line in a telephone ring system therein, in accordance with my invention, showing the digital controller functions.

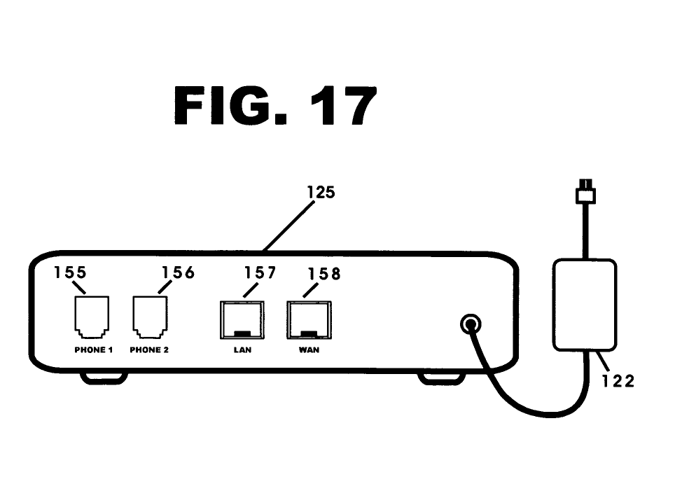

FIG. 17 is a rear view of a telephone adapter similar to that shown in FIG. 16. 10 A pair of telephone line jacks for the telephones are shown at 155 and 156. Mounted in the housing of the adapter 125 are a connector 157 for the output of the computer and a connector 158 for the input from the cable modem 120.

What I have described is a system, apparatuses and a method for use in a facsimile machine, a telephone and a VoIP system, for simulating an “in use” condition in a telephone line in those devices, so that incoming calls will get a busy signal and, therefore, will not ring all telephones on that line.

What is claimed is:

1. In a facsimile machine having a telephone system having at least one telephone line, and a circuit within said facsimile machine which provides a busy signal in said telephone line when a telephone is in an “in use” mode, a simulation means connected to said line within said facsimile machine to simulate said “in use” mode, comprising;
a. switch means in said circuit, switchable between an open circuit position and a closed circuit position;
b. relay means connected to said switch means to switch said switch means between said positions;
c. controller means connected to said relay means to cause said relay means to switch said switch means as aforesaid; and
d. time set means connected to said controller means to set time intervals that the controller means causes the relay means to switch said switch means as aforesaid.

2. The system of claim 1 further comprising a transistor connected to the controller means and responsive to a signal from the controller means to allow the relay means to close said circuit.

3. The system of claim 1 wherein the time set means provides the following functions:
a. a “Set Timer On” function to repeatedly control the start of the simulated “in use” mode in minutes and hours;
b. a “Set Timer Off” function to repeatedly control the end of the simulated “in use” mode in minutes and hours;
c. a repeat function whereby once set, the two functions set out in 3.a and 3.b above remain as set until they are changed;
d. a clock and a “Time Set” function to set said clock to the time of day in minutes and hours;
e. a “Reset line” function for releasing the prior “set” times, whereby the telephone is brought back to its normal operating mode; while, at the same time, saving the repeatable functions in place for the next day; and
f. an “On/Off” function for controlling the operation of the simulation means.

4. The system of claim 1 further comprising a non-repeatable “Do Not Disturb” function providing a second simulated “in use” mode function which can be pre-programed for a second set interval of time, such that each time the “Do Not Disturb” function is invoked, it adds the same second set time interval to the previously set second interval of time.

5. The system of claim 3 further comprising a non-repeatable “Do Not Disturb” function providing a second simulated “in use” mode function which can be pre-programed for a second set interval of time, such that each time the “Do Not Disturb” function is invoked, it adds the same second set time interval to the previously set second interval of time.

6. In a facsimile machine having a plurality of telephone lines and a circuit within said facsimile machine which provides a busy signal in a plurality of telephone lines when a telephone is in an “in use” mode, a simulation means connected to said line to simulate said “in use” mode, comprising;
a. switch means in said circuit, switchable between an open circuit position and a closed circuit position;
b. relay means connected to said switch means to switch said switch means between said positions;
c. controller means connected to said relay means to cause said relay means to switch said switch means as aforesaid; and
d. time set means connected to said controller means to set time intervals that the controller means causes the relay means to switch said switch means as aforesaid.

7. A method of simulating an “in use” mode in a facsimile machine having at least one telephone line, and a circuit within said facsimile machine which provides a busy signal to said telephone line when a telephone is in an “in use” mode, comprising:
providing a switch means in said circuit, switchable between an open circuit position and a closed circuit position; providing a relay means connected to said switch means to switch said switch means between said positions; providing a controller means connected to said relay means to cause said relay means to switch said switch means as aforesaid; and providing time set means connected to said controller means to set time intervals that the controller means causes the relay means to switch said switch means as aforesaid.

8. The method of claim 7 wherein the controller means further comprises a transistor and the method further comprises providing a signal from the controller means to said transistor to allow the relay means to close said circuit.

9. The method of claim 7 wherein the time set means further provides the following functions:
a. a “Set Timer On” function to repeatedly control the start of the simulated “in use” mode in minutes and hours;
b. a “Set Timer Off” function to repeatedly control the end of the simulated “in use” mode in minutes and hours;
c. a repeat function whereby once set, the two functions set out in 3.a and 3.b above remain as set until they are changed;
d. a clock and a “Time Set” function to set said clock to the time of day in minutes and hours;
e. a “Reset line” function for releasing the prior “set” times, whereby the telephone is brought back to its normal operating mode; while, at the same time, saving the repeatable functions in place for the next day; and
f. an “On/Off‘ function for controlling the operation of the simulation means.

10. The method of claim 7 further comprising providing a non-repeatable “Do Not Disturb” function providing a second simulated “in use” mode function which can be pre-programed for a second set interval of time, such that each time the “Do Not Disturb” function is invoked, it adds the same second set time interval to the previously set second interval of time.

11. The method of claim 9 further comprising providing a non-repeatable “Do Not Disturb” function providing a second simulated “in use” mode function which can be pre-programed for a second set interval of time, such that each time the “Do Not Disturb” function is invoked, it adds the same second set time interval to the previously set second interval of time.

12. In a telephone system having at least one telephone and at least one line, and a circuit within said telephone which provides a busy signal in said telephone line when a telephone is in an “in use” mode, a simulation means connected to said line within said telephone to simulate said “in use” mode, comprising;
a. switch means in said circuit, switchable between an open circuit position and a closed circuit position;
b. relay means connected to said switch means to switch said switch means between said positions;
c. controller means connected to said relay means to cause said relay means to switch said switch means as aforesaid; and
d. time set means connected to said controller means to set time intervals that the controller means causes the relay means to switch said switch means as aforesaid.

13. The system of claim 12 further comprising a transistor connected to the controller means and responsive to a signal from the controller means to allow the relay means to close said circuit.

14. The system of claim 12 wherein the time set means provides the following functions:
a. a “Set Timer On” function to repeatedly control the start of the simulated “in use” mode in minutes and hours;
b. a “Set Timer Off” function to repeatedly control the end of the simulated “in use” mode in minutes and hours;
c. a repeat function whereby once set, the two functions set out in 3.a and 3.b above remain as set until they are changed;
d. a clock and a “Time Set” function to set said clock to the time of day in minutes and hours;
e. a “Reset line” function for releasing the prior “set” times, whereby the telephone is brought back to its normal operating mode; while, at the same time, saving the repeatable functions in place for the next day; and
f. an “On/Off” function for controlling the operation of the simulation means.

15. The system of claim 12 further comprising a non-repeatable “Do Not Disturb” function providing a second simulated “in use” mode function which can be pre-programed for a second set interval of time, such that each time the “Do Not Disturb” function is invoked, it adds the same second set time interval to the previously set second interval of time.

16. The system of claim 14 further comprising a non-repeatable “Do Not Disturb” function providing a second simulated “in use” mode function which can be pre-programed for a second set interval of time, such that each time the “Do Not Disturb” function is invoked, it adds the same second set time interval to the previously set second interval of time.

17. In a telephone system having a telephone and a plurality of telephone lines connected to the telephone and a circuit within said telephone which provides a busy signal in a plurality of said telephone lines when a telephone is in an “in use” mode, a simulation means connected to said line to simulate said “in use” mode, comprising;
a. switch means in said circuit, switchable between an open circuit position and a closed circuit position;
b. relay means connected to said switch means to switch said switch means between said positions;
c. controller means connected to said relay means to cause said relay means to switch said switch means as aforesaid; and
d. time set means connected to said controller means to set time intervals that the controller means causes the relay means to switch said switch means as aforesaid.

18. A method of simulating an “in use” mode in a telephone having at least one telephone line, and a circuit within said telephone which provides a busy signal to said telephone line when said telephone is in an “in use” mode, comprising:
providing a switch means in said circuit, switchable between an open circuit position and a closed circuit position; providing a relay means connected to said switch means to switch said switch means between said positions; providing a controller means connected to said relay means to cause said relay means to switch said switch means as aforesaid; and providing time set means connected to said controller means to set time intervals that the controller means causes the relay means to switch said switch means as aforesaid.

19. The method of claim 18 wherein the controller means further comprises a transistor and the method further comprises providing a signal from the controller means to said transistor to allow the relay means to close said circuit.

20. The method of claim 18 wherein the time set means further provides the following functions:
a. a “Set Timer On” function to repeatedly control the start of the simulated “in use” mode in minutes and hours;
b. a “Set Timer Off” function to repeatedly control the end of the simulated “in use” mode in minutes and hours;
c. a repeat function whereby once set, the two functions set out in 3.a and 3.b above remain as set until they are changed;
d. a clock and a “Time Set” function to set said clock to the time of day in minutes and hours;
e. a “Reset line” function for releasing the prior “set” times, whereby the telephone is brought back to its normal operating mode; while, at the same time, saving the repeatable functions in place for the next day; and
f. an “On/Off‘function for controlling the operation of the simulation means.

21. The method of claim 18 further comprising providing a non-repeatable “Do Not Disturb” function providing a second simulated “in use” mode function which can be pre-programed for a second set interval of time, such that each time the “Do Not Disturb” function is invoked, it adds the same second set time interval to the previously set second interval of time.

22. The method of claim 20 further comprising providing a non-repeatable “Do Not Disturb” function providing a second simulated “in use” mode function which can be pre-programed for a second set interval of time, such that each time the “Do Not Disturb” function is invoked, it adds the same second set time interval to the previously set second interval of time.

23. In a VoIP telephone system having at least one telephone adaptor and at least one telephone line, and a circuit within said adaptor which provides a busy signal in said telephone line when a telephone is in an “in use” mode, a simulation means connected to said line within said facsimile machine to simulate said “in use” mode, comprising;
a. switch means in said circuit, switchable between an open circuit position and a closed circuit position;
b. relay means connected to said switch means to switch said switch means between said positions;
c. controller means connected to said relay means to cause said relay means to switch said switch means as aforesaid; and
d. time set means connected to said controller means to set time intervals that the controller means causes the relay means to switch said switch means as aforesaid.

24. The system of claim 23 further comprising a transistor connected to the controller means and responsive to a signal from the controller means to allow the relay means to close said circuit.

25. The system of claim 23 wherein the time set means provides the following functions:
a. a “Set Timer On” function to repeatedly control the start of the simulated “in use” mode in minutes and hours;
b. a “Set Timer Off” function to repeatedly control the end of the simulated “in use” mode in minutes and hours;
c. a repeat function whereby once set, the two functions set out in 3.a and 3.b above remain as set until they are changed;
d. a clock and a “Time Set” function to set said clock to the time of day in minutes and hours;
e. a “Reset line” function for releasing the prior “set” times, whereby the telephone is brought back to its normal operating mode; while, at the same time, saving the repeatable functions in place for the next day; and
f. an “On/Off” function for controlling the operation of the simulation means.

26. The system of claim 23 further comprising a non-repeatable “Do Not Disturb” function providing a second simulated “in use” mode function which can be pre-programed for a second set interval of time, such that each time the “Do Not Disturb” function is invoked, it adds the same second set time interval to the previously set second interval of time.

27. The system of claim 25 further comprising a non-repeatable “Do Not Disturb” function providing a second simulated “in use” mode function which can be pre-programed for a second set interval of time, such that each time the “Do Not Disturb” function is invoked, it adds the same second set time interval to the previously set second interval of time.

28. In a VoIP telephone system having a telephone adaptor and having a plurality of telephone lines and a circuit within said adaptor which provides a busy signal in a plurality of telephone lines when a telephone is in an “in use” mode, a simulation means connected to said line to simulate said “in use” mode, comprising;
a. switch means in said circuit, switchable between an open circuit position and a closed circuit position;
b. relay means connected to said switch means to switch said switch means between said positions;
c. controller means connected to said relay means to cause said relay means to switch said switch means as aforesaid; and
d. time set means connected to said controller means to set time intervals that the controller means causes the relay means to switch said switch means as aforesaid.

29. A method of simulating an “in use” mode in a VoIP system having at least one telephone adaptor and having at least one telephone line, and a circuit within said adaptor which provides a busy signal to said telephone line when a telephone is in an “in use” mode, comprising: providing a switch means in said circuit, switchable between an open circuit position and a closed circuit position; providing a relay means connected to said switch means to switch said switch means between said positions; providing a controller means connected to said relay means to cause said relay means to switch said switch means as aforesaid; and providing time set means connected to said controller means to set time intervals that the controller means causes the relay means to switch said switch means as aforesaid.

30. The method of claim 29 wherein the controller means further comprises a transistor and the method further comprises providing a signal from the controller means to said transistor to allow the relay means to close said circuit.

31. The method of claim 29 wherein the time set means further provides the following functions:
a. a “Set Timer On” function to repeatedly control the start of the simulated “in use” mode in minutes and hours;
b. a “Set Timer Off” function to repeatedly control the end of the simulated “in use” mode in minutes and hours;
c. a repeat function whereby once set, the two functions set out in 3.a and 3.b above remain as set until they are changed;
d. a clock and a “Time Set” function to set said clock to the time of day in minutes and hours;
e. a “Reset line” function for releasing the prior “set” times, whereby the telephone is brought back to its normal operating mode; while, at the same time, saving the repeatable functions in place for the next day; and
f. an “On/Off” function for controlling the operation of the simulation means.

32. The method of claim 29 further comprising providing a non-repeatable “Do Not Disturb” function providing a second simulated “in use” mode function which can be pre-programed for a second set interval of time, such that each time the “Do Not Disturb” function is invoked, it adds the same second set time interval to the previously set second interval of time.

33. The method of claim 31 further comprising providing a non-repeatable “Do Not Disturb” function providing a second simulated “in use” mode function which can be pre-programed for a second set interval of time, such that each time the “Do Not Disturb” function is invoked, it adds the same second set time interval to the previously set second interval of time.
